(19) United States
(12) Patent Application Publication
(10) Pub. No.: US 2014/0236606 A1
(43) Pub. Date: Aug. 21, 2014

(54) MEDICATION MANAGEMENT SYSTEM

(71) Applicants: KING SAUD BIN ABDULAZIZ UNIVERSITY FOR HEALTH SCIENCES, (US); KING ABDULLAH NTERNATIONAL MEDICAL RESEARCH CENTER, Riyadh (SA); NATIONAL GUARD HEALTH AFFAIRS, Riyadh (SA)

(72) Inventors: SALEM AL SUWAIDAN, RIYADH (SA); IBRAHIM ALBATHI, RIYADH (SA)

(73) Assignees: KING ABDULLAH INTERNATIONAL MEDICAL RESEARCH CENTER, Riyadh (SA); NATIONAL GUARD HEALTH AFFAIRS, Riyadh (SA); KING SAUD BIN ABDULAZIZ UNIVERSITY FOR HEALTH SCIENCES, Riyadh (SA)

(21) Appl. No.: 13/769,792

(22) Filed: Feb. 18, 2013

(51) Int. Cl. G06F 19/00; G06Q 50/22

(52) U.S. Cl. CPC G06F 19/3456; G06Q 50/22
USPC 705/2

(57) ABSTRACT

The medication management system is divided into hospital server, pharmacy server, and patient mobile device. The hospital server and pharmacy server contain all patient active and inactive medication profiles. The hospital software runs on the hospital server, which is an intermediary between the pharmacy software (PMR—Pharmacy Medication Records) and the patient software. The platform can communicate with different types of pharmacy data bases and software, and at the same time can be used as a type of an encoding and decoding platform to convert from one pharmacy database to anther automatically and eliminate the long tedious effort done by humans to do it manually.

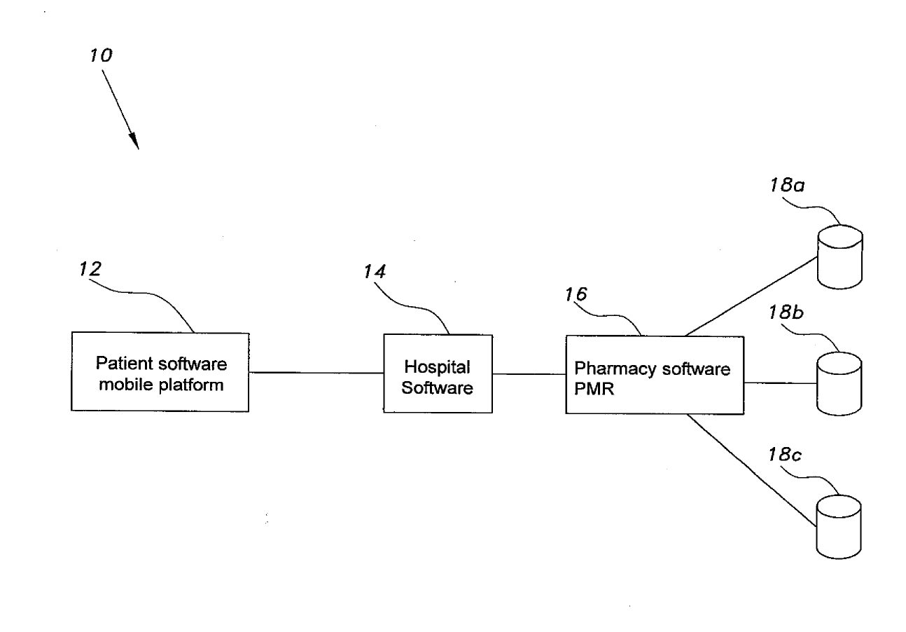

### BACKGROUND OF THE INVENTION

1. Field of the Invention

The present invention relates to medication management, and particularly to a medication management system allowing a patient to receive medication dosing instructions based on information from disparate pharmacy databases and extracted pharmacy medication records data.

2. Description of the Related Art

Healthcare environments, such as hospitals or clinics, include information systems, such as hospital information systems, medication administration records (MAR), and pharmacy medication records (PMR). The information stored may include patient medical histories, management information, and/or scheduling information, for example. The information may be centrally stored or stored at a plurality of locations. Healthcare practitioners may desire to access patient information or other information at various points in a healthcare workflow. For example, during treatment, medical personnel may access patient information that is stored in a medical information system, such as the medications currently being taken by the patient.

Healthcare providers are under constant pressure to provide treatment to their patients as effectively and efficiently as possible. To do so, providers must review large amounts of data from a variety of disparate sources. As the prevalence of pharmaceuticals continues to grow, complete and correct medication information is especially critical to providers in preventing potentially life-threatening medication errors.

Despite the gravity of these concerns, comprehensive medication information remains difficult to obtain for several reasons. First, many patients receive different medications in the hospital and ambulatory settings, each of which may use a different medication management system. Additionally, medications that are ordered by a provider may not actually be taken by the patient. Moreover, over-the-counter medications and medications provided by an alternative medicine provider may not be included in a patient's medical records.

In addition to understanding what medications a patient is currently taking, a provider must also recognize how the different medications interact with one another. Clinical decision support systems seek to provide such assistance to healthcare providers. For example, clinical decision support systems may perform interaction checking on prescription orders for possible adverse drug interactions. Interaction checking may include, for example, drug-to-drug interactions, dose range warnings, drug allergies, duplicate drugs, and/or therapeutic duplication.

Currently available applications are unable to manage a patient's medications obtained from a variety of sources that include doctor's office samples, 90-day mail-in prescriptions, pharmacy prescriptions, over-the-counter providers, and dietary supplements. Moreover, these applications are unable to provide clinical decision support based on a comprehensive understanding of a patient's medication information across multiple disparate sources. Existing systems are not standardized in their medical formularies, and accepting external medication information into the system may create liability issues or problems associated with real-time decision support.

Thus, a medication management system solving the aforementioned problems is desired.

### SUMMARY OF THE INVENTION

The medication management system is divided into a hospital-pharmacy portion and a patient portion. The hospital-pharmacy portion contains all of the patient's active and inactive medication profiles. The hospital software runs on a server, which is an intermediary between the pharmacy software (PMR—Pharmacy Medication Records) and the patient software. The platform can communicate with different types of pharmacy databases and software, and at the same time can be used as a type of an encoding and decoding platform to convert from one pharmacy database to anther automatically and eliminate the long tedious effort when humans to do it manually.

These and other features of the present invention will become readily apparent upon further review of the following specification and drawings.

### BRIEF DESCRIPTION OF THE DRAWINGS

The sole drawing FIGURE is a block diagram of a medication management system according to the present invention.

Similar reference characters denote corresponding features consistently throughout the attached drawings.

### DETAILED DESCRIPTION OF THE PREFERRED EMBODIMENTS

As shown in the drawing, the medication management system 10 includes a hospital server 14, a pharmacy server 16, and a patient application device 12. The hospital server 14 and the pharmacy server 16 contain all the patient's information, including active and inactive medication profiles. The active medications are those drugs which the patient is concurrently on after the last visit with their doctors; while the inactive medications are those that have been used by the patient in the past, but are kept for patient medication history. The hospital software is included in the server 14, which mediates communication between the pharmacy software in the pharmacy server 16 (PMR—Pharmacy Medication Records) and the patient software in a patient mobile device 12, such as a cell phone or smart phone. The server 14 is in charge of extracting data from the PMR and encoding it to the format of the patient software on the patient device 12.

The patient's device and software 12 is a mobile phone that uses a communication protocol based on GPRS, Bluetooth and SMS, and/or Wi-Fi. The doses and method of dispensing will be through a special code established for each dose. The reason for different communication is to overcome different obstacles and communicate scenarios and location change. Voice recognition software is installed with the application.

Medicine names can be spoken only in English (alternative: labeling medicine as a predefined method of numbering between the system and labeling system to also overcome the complexity of medicine naming for patinas especially older people).

The system 10 solves the problem of automatically updating patient doses through communication without the need of patient visits to the hospital. The system 10 can speak the doses in different languages for people who can't read. The system 10 provides the ability for the doctor or pharmacy to track and follow patient medication and doses and how the patient is following the instruction and amount of medications remaining in a more accurate way. The server side 16 in the pharmacy is able to communicate with different pharmacy databases, e.g., disparate pharmacy databases 18a, 18b, and 18c, and the system 10 is easily adapted by disparate medical organizations and hospitals.

The system 10 has a unique feature of updating itself automatically without the interference of the doctor or pharmacy doctors. Also, it will allow hospitals to track the following up of patients to the dose schedules and instructions. The system 10 also is unique in term of different communication methods it can communicate with.

The system 10 can communicate using different communication methods, which will reduce the amount of missing any data in case any communication is lost. The system 10 will do automatic update to the patient doses on the device 12 by extracting it and getting it from the pharmacy system 16 without the need of visiting the pharmacy. The pharmacy and the doctor will have the ability to predict more accurately the dosage scheduling and amount based on data provided by the system 10. The server side 16 will have the ability to communicate with different pharmacy databases 18a, 18b, 18c. The system 10 later will have multiple language support. The device 10 has voice spoken commands and instructions. One of the future plans is to see the possibility of designing a dedicated device other than the current proposal, which is a mobile phone 12 as for current approach.

The system 10 will be a benefit for the patient with poly-pharmacy, which we tend to define as when the patient is receiving five or more doses. Poly-pharmacy also can be defined as concurrent use of multiple drugs. Also, on server side 16, the system 10 can be used for a communication platform between different pharmacy database applications associated with databases 18a, 18b, and 18c and record data, which will help in exchanging information in the future.

The system 10 has the ability to provide a dose remaining system that updates itself with patient medication records accessible to the pharmacy server 16 and doses automatically without the interference of the doctor and without the need of visiting the pharmacy or clinic. Moreover, the system 10 will have the feature of voice synthesizers, which means speaking the dose name, method and amount to the patient without the need of reading it. Also, it will have ability to adapt different languages. Another interesting target is the pharmacy or server side platform 16 in which the server side program provides a software platform that can communicate with different types of pharmacy databases and software, and at same time, can be used as a type of an encoding and decoding platform to convert from one pharmacy database to anther automatically while eliminating the long tedious effort when humans to do it manually.

It is to be understood that the present invention is not limited to the embodiments described above, but encompasses any and all embodiments within the scope of the following claims.

We claim:

1. A medication management system, comprising:
a plurality of disparate pharmacy databases;
a pharmacy server in communication with the disparate pharmacy databases;
a hospital server in communication with the pharmacy server and adapted to aggregate medication data from the pharmacy server;
means for extracting pharmacological dosing instructions from the medication data aggregated by the hospital server;
means for sending the pharmacological dosing instructions to an end user mobile device through a wireless network.

2. The medication management system according to claim 1, further comprising means for storing all patient information, including active and inactive medication profiles, the active medication profiles being stored to maintain a record of medications patients are currently on, the inactive medication profiles being stored to maintain a record of medications patients have historically been on.

3. The medication management system according to claim 1, wherein said wireless network is a cellular telecommunications network implementing General Packet Radio Services (GPRS) data transfers, said means for sending encoding the pharmacological dosing instructions for GPRS data transmission.

4. The medication management system according to claim 1, wherein said wireless network includes data transmission by Bluetooth protocol, said means for sending encoding the pharmacological dosing instructions for transmission by Bluetooth.

5. The medication management system according to claim 1, wherein said wireless network is a cellular telecommunications network implementing short message service (SMS) text messaging, said means for sending encoding the pharmacological dosing instructions for transmission by SMS.

6. The medication management system according to claim 1, wherein said wireless network is a Wi-Fi network implementing wireless computer data transmission over the Internet through a wireless local area network (WLAN), said means for sending encoding the pharmacological dosing instructions for transmission by Wi-Fi.

7. The medication management system according to claim 1, wherein said means for sending includes means for sending the pharmacological dosing instructions by voice transmission.

8. The medication management system according to claim 1, wherein said means for extracting pharmacological dosing instructions includes means for extracting the pharmacological dosing instructions by labeling medicine according to a numbering system accepted by the plurality of disparate pharmacy databases and the pharmacy server.

9. The medication management system according to claim 1, further comprising means for automatically updating patient doses through communication without need of the patient visiting the hospital.

10. The medication management system according to claim 1, further comprising:
means for tracking and following patient medication and dosage and patient compliance with a specified dosing regimen; and
means for distributing the tracking and patient compliance information to the pharmacy server.

11. The medication management system according to claim 1, further comprising:
means for communicating with a plurality of pharmacy database applications associated with said plurality of disparate pharmacy databases; and
means for encoding and decoding to convert from any one of said disparate pharmacy databases to any other of said disparate pharmacy databases.

12. The medication management system according to claim 1, further comprising means for updating dose remaining for the patient to take via computation based on patient medication records accessible to said pharmacy server.

13. The medication management system according to claim 1, wherein said means for sending includes means for sending the pharmacological dosing instructions by voice transmission, the medical management system further comprising means for transmitting the pharmacological dosing instructions in a language designated by the end user.
